(19) United States
(12) Patent Application Publication
(10) Pub. No.: US 2025/0236338 A1
(43) Pub. Date: Jul. 24, 2025

(54) ADJUSTMENT ASSEMBLY FOR A VEHICLE FRAME

(71) Applicant: Polaris Industries Inc., Medina, MN (US)

(72) Inventors: Scott T. Mazour, Wyoming, MN (US); Joseph D. Martens, Woodbury, MN (US)

(73) Assignee: Polaris Industries Inc., Medina, MN (US)

(21) Appl. No.: 19/023,746

(22) Filed: Jan. 16, 2025

Related U.S. Application Data
(60) Provisional application No. 63/622,303, filed on Jan. 18, 2024.

(51) Int. Cl. B62D 21/11; B62D 65/02

(52) U.S. Cl. CPC B62D 21/11; B62D 65/02

(57) ABSTRACT

A vehicle, system, and method for adjusting components of a vehicle is provided. The vehicle includes a plurality of ground engaging members, a frame assembly supported by the plurality of ground engaging members including a front subframe, a powertrain operatively coupled to at least one of the plurality of ground engaging members, a plurality of body panels supported by the front subframe including a front fascia, and an adjustment assembly operably coupled to the front subframe. The adjustment assembly may include a body and at least one adjuster removably coupled to the body. The at least one adjuster is rotatable relative to the body such that rotation of the at least one adjuster translates the front subframe within at least two degrees of freedom.

### CROSS-REFERENCE TO RELATED APPLICATIONS

The present application claims priority to U.S. Provisional Patent Application Ser. No. 63/622,303, filed Jan. 18, 2024, the entire disclosure of which is referenced herein.

### BACKGROUND

Recreational vehicles, such as all-terrain vehicles (ATVs), utility vehicles (UVs), three-wheeled vehicles, snowmobiles, and side-by-side vehicles are widely used for recreational purposes. These vehicles might be used on roads, trails, dunes, or other types of terrain. Various systems and methods have been developed to manufacture such vehicles.

### SUMMARY

As set forth above, embodiments provided herein relate to an adjustment assembly for a vehicle, which may be used in vehicle manufacturing. Exemplary embodiments include, but are not limited to, the following:

In an exemplary embodiment of the present disclosure, a vehicle is provided. The vehicle may include a plurality of ground engaging members, a frame assembly supported by the plurality of ground engaging members including a main frame and a front subframe, a powertrain operatively coupled to at least one of the plurality of ground engaging members, a plurality of body panels supported by the front subframe including a front fascia, and an adjustment assembly operably coupled to the front subframe. The adjustment assembly may include a body and at least one adjuster coupled to the body. The at least one adjuster is rotatable relative to the body and rotation of the at least one adjuster translates the front subframe relative to the main frame. The adjustment assembly is configured to translate within at least two degrees of freedom.

In another exemplary embodiment thereof, an adjustment assembly for adjusting a position of a front subframe of a vehicle relative to a main frame is provided. The adjustment assembly may include a body and at least one adjuster removably coupled o the body. The at least one adjuster is rotatable relative to the body and the adjustment assembly is configured to translate within at least two degrees of freedom.

In another exemplary embodiment thereof, a method is provided. The method may include providing a plurality of ground engaging members, providing a powertrain operatively coupled to at least one of the plurality of ground engaging members, providing a frame assembly supported by the plurality of ground engaging members including a main frame and a front subframe, providing a plurality of body panels supported by the frame assembly including a front fascia and a hood, providing an adjustment assembly comprising at least one adjuster and a body where the adjustment assembly is operatively coupled to the front subframe, coupling the at least one adjuster to the body, rotating the at least one adjuster to translate the front subframe relative to the main frame where the adjustment assembly is configured to translate within at least two degrees of freedom, aligning the front subframe relative to the main frame, and coupling the front subframe to the frame assembly.

While multiple embodiments are disclosed, still other embodiments of the presently disclosed subject matter will become apparent to those skilled in the art from the following detailed description, which shows and describes illustrative embodiments of the disclosed subject matter. Accordingly, the drawings and detailed description are to be regarded as illustrative in nature and not restrictive.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 illustrates a perspective view of an exemplary vehicle of the present disclosure;

FIG. 2 illustrates a front left of the vehicle of FIG. 1;

FIG. 3 illustrates a perspective view of a frame assembly the vehicle of FIG. 1, with body panels removed to better illustrate the frame and other components;

FIG. 4 illustrates a detailed front left perspective view of the frame assembly of FIG. 3;

FIG. 5 illustrates a side view of the adjustment assembly of FIG. 4;

FIG. 6 illustrates a side view of the adjustment assembly of FIG. 5 including at least one adjuster;

FIGS. 7A, 7B, and 7C illustrate rear, side, and front views, respectively, of one of the adjusters of FIG. 6;

FIG. 8 illustrates a rear left perspective view of the adjustment assembly of FIG. 6;

FIG. 9 illustrates a rear left perspective view of the frame assembly of FIG. 3 including a front fascia and a hood;

FIG. 10 illustrates a perspective view of a gap between the front fascia and hood of FIG. 9;

FIG. 11 illustrates a method of manufacturing the vehicle of FIG. 1 using the adjustment assembly of FIG. 8;

FIG. 12 illustrates a front right perspective view of another embodiment of the adjustment assembly;

FIG. 13 illustrates a front right perspective view of the adjustment assembly of FIG. 12 including at least one adjuster;

FIGS. 14A, 14B, and 14C illustrate perspective, front, and side views, respectively, of one of the adjusters of FIG. 13;

FIG. 15 illustrates another front right perspective view of the adjustment assembly of FIG. 13; and

FIG. 16 illustrates a method of manufacturing the vehicle of FIG. 1 using the adjustment assembly of FIG. 15.

Corresponding reference characters indicate corresponding parts throughout the several views. Although the drawings represent embodiments of the present disclosure, the drawings are not necessarily to scale, and certain features may be exaggerated in order to better illustrate and explain the present disclosure. The exemplification set out herein illustrates an embodiment of the disclosure, in one form, and such exemplifications are not to be construed as limiting the scope of the disclosure in any manner.

### DETAILED DESCRIPTION OF THE DRAWINGS

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention. Rather, the embodiments are chosen and described so that others skilled in the art may utilize their teachings. While the present disclosure is primarily directed to a utility vehicle, it should be understood that the features disclosed herein may have application to other types of vehicles such as other all-terrain vehicles, motorcycles, snowmobiles, and golf carts.

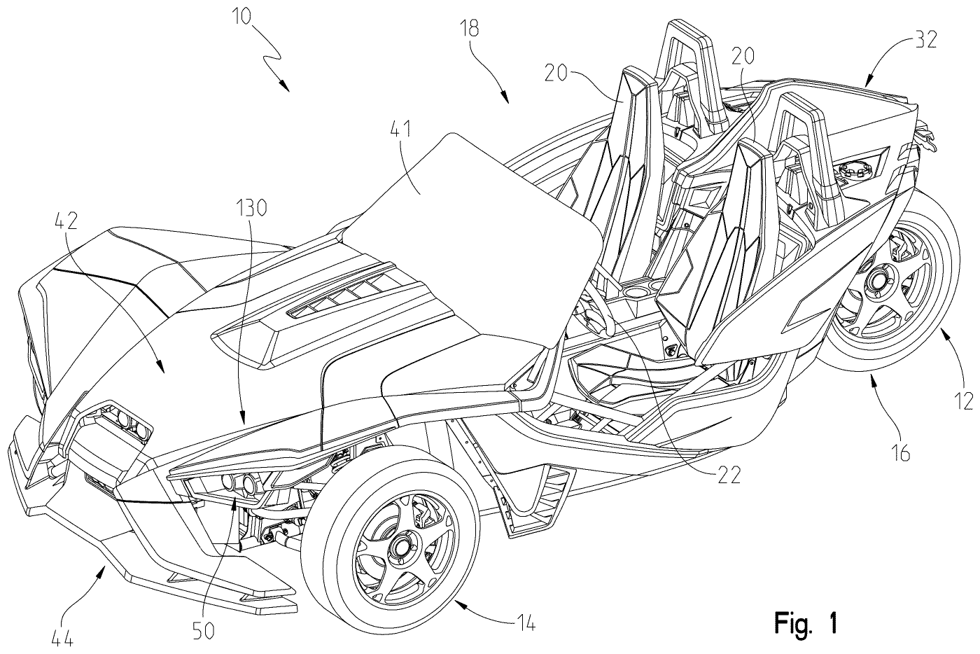

Referring to FIG. 1, an illustrative embodiment of an exemplary vehicle 10 is shown. It should be appreciated that vehicle 10 is an exemplary recreational vehicle, particularly a side-by-side seating type recreational vehicle. Although exemplary vehicle 10 is shown, it should be appreciated that other side-by-side recreational vehicles may incorporate the teachings disclosed herein. In embodiments, vehicle 10 may include the systems and layout described in in U.S. patent application Ser. No. 13/425,963 (Attorney Docket PLR-11-24814.04P-US-e), the entire disclosure of which is incorporated by reference.

Vehicle 10 is shown as a three-wheeled vehicle including a plurality of ground engaging members 12, illustratively front wheels 14 and a single rear wheel 16. Exemplary ground engaging members include skis, endless tracks, wheels, non-pneumatic tires, and other suitable devices which support vehicle 10 relative to the ground.

Vehicle 10 includes an operator area 18, which may be an open-air operator area, having seats 20. Seats 20 may include an operator seat and a passenger seat in a side-by-side relationship. Seats 20 are illustrated as side-by-side bucket seats but other exemplary seats such as a bench seat may be included. Further, in embodiments, vehicle 10 may be a crew style vehicle having a second row of seating behind seats 20 to provide additional seating options. The operator area 18 further includes a steering input 22, illustratively a steering wheel, operatively coupled to at least front wheels 14 to alter a direction of travel of vehicle 10.

Vehicle 10 further includes a frame assembly 24 supported above the ground by the plurality of ground engaging members 12. Frame assembly 24 may include cast portions, sheet metal portions, weldments, tubular components, or a combination thereof. Frame assembly 24 may be considered a main frame of vehicle 10 and includes a front frame assembly 26, a middle frame assembly 28, and a rear frame assembly 30. Front frame assembly 26 extends longitudinally forward of middle frame assembly 28 and may support components of vehicle 10 positioned longitudinally forward of the operator area 18. Middle frame assembly 28 is positioned between front frame assembly 26 and rear frame assembly 30 and is configured to support, among other components, seats 20 including the operator seat and one or more passenger seats. Rear frame assembly 30 extends rearwardly from middle frame assembly 28 and may support a rear cargo area 32. Rear cargo area 32 may include a storage area which may be covered or uncovered, as desired.

Vehicle 10 includes a plurality of body panels 34 supported by frame assembly 24. The plurality of body panels 34 may include a front body portion 36, a middle body portion 38, and a rear body portion 40. Front body portion 36 may be supported by front frame assembly 26, middle body portion 38 may be supported by middle frame assembly 28, and rear body portion 40 may be support by rear frame assembly 30. In some embodiments, front body portion 36 includes a windshield 41, a hood 42 and a front fascia 44. Front fascia 44 may support fixtures including, but not limited to, one or more headlight assemblies 50, a front bumper, and grilles. In some embodiments, middle body portion 38 includes one or more doors 46. In some embodiments, rear body portion 40 includes a cargo area cover 48.

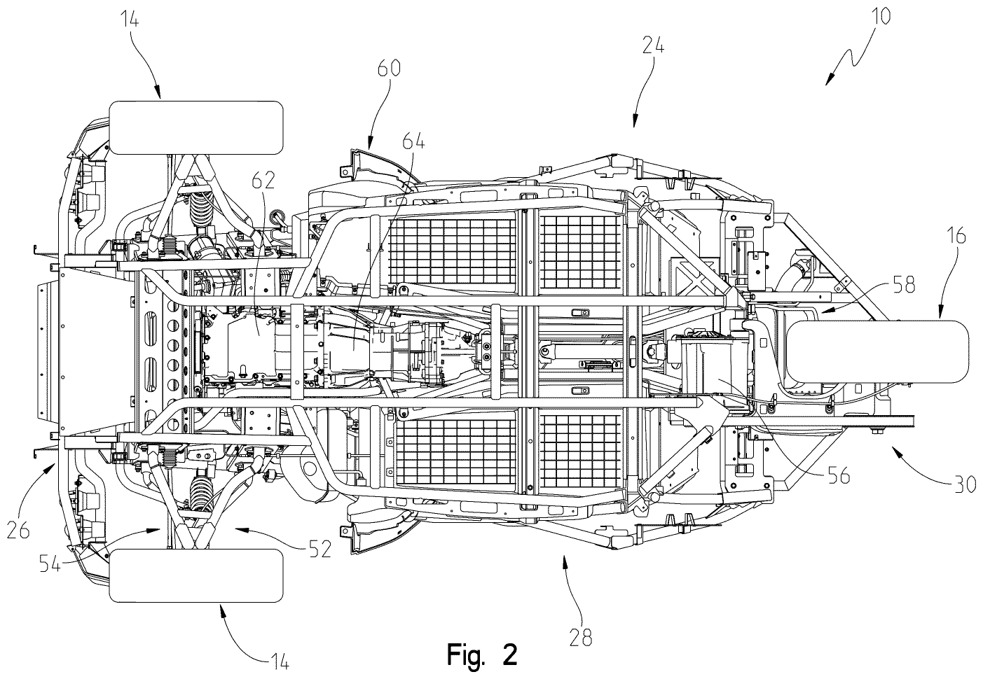

Referring to FIG. 2, an underside of vehicle 10 is shown. Vehicle 10 includes a front suspension system 52, a front steering system 54, a rear final drive system 56, and a rear suspension 58, each of which are supported by the frame assembly 24. Vehicle 10 also includes a powertrain 60 supported by the frame assembly 24. The powertrain 60 may include numerous high voltage carrying components including chargers, batteries, prime mover and/or drive train that provides power from the prime mover to at least one ground engaging member 14, 16. The prime mover 62, may include, but is not limited to, an electric motor, a combustion engine, or a hybrid system. Powertrain 60 may further include a transmission 64, which may be an automatic transmission or a continuously variable transmission (CVT).

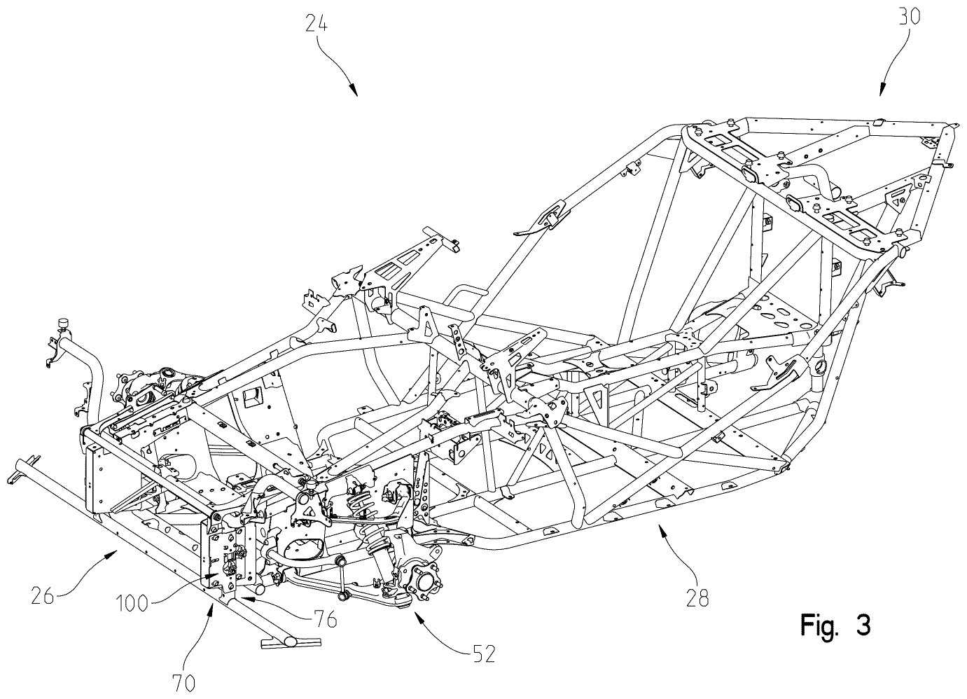

Referring to FIG. 3, a front subframe 70 is included on vehicle 10. Front subframe 70 may be separate from and coupled to frame assembly 24 or may be part of frame assembly 24. In particular, front subframe 70 may be included with the front frame assembly 26 or coupled to front frame assembly 26. Front subframe 70 may support one or more body panels in the plurality of body panels 34, including but not limited to, front fascia 44.

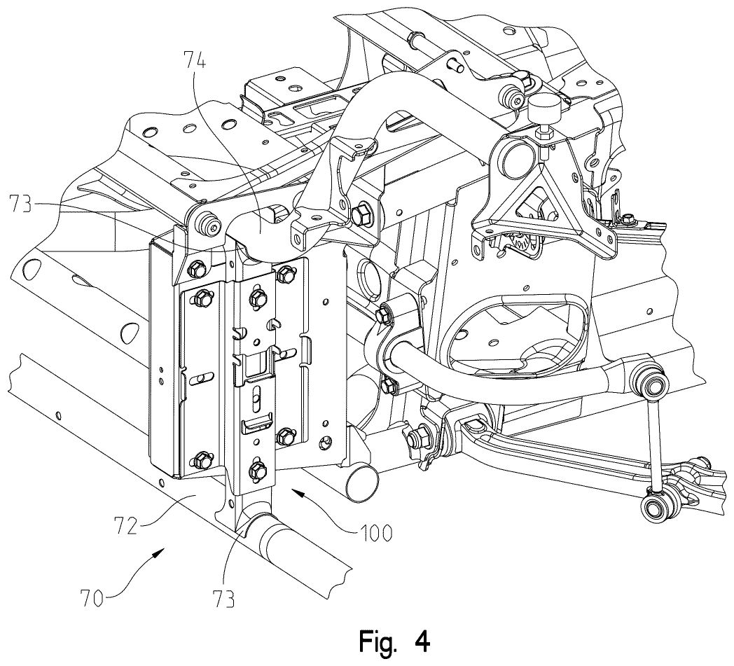

Referring to FIGS. 4-6, front subframe 70 is illustratively shown as mounted or coupled to various components of frame assembly 24 using adjustment assembly 100. The adjustment assembly 100 may be removably coupled to or integral with front subframe 70. In one embodiment as described herein, adjustment assembly 100 may be used to mount front subframe 70, and by extension, front fascia 44, to frame assembly 24. Although front fascia 44 and front subframe 70 are discussed throughout, any frame assembly component or body panel of the plurality of body panels 34 may be mounted to any portion of frame assembly 24 using adjustment assembly 100. Illustratively, adjustment assembly 100 is positioned longitudinally forward of operator area 18.

Adjustment assembly 100 may extend between a first front subframe tube 72 and a second front subframe tube 74 where at least portions of first and second front subframe tubes 72, 74 are generally parallel to each other. As shown, first and second front subframe tubes 72, 74 extend laterally across the width of vehicle 10, however, adjustment assembly 100 may be positioned at any position along front subframe 70. Body 102 may include one or more surfaces 73 to interface with first and second front subframe tubes 72, 74.

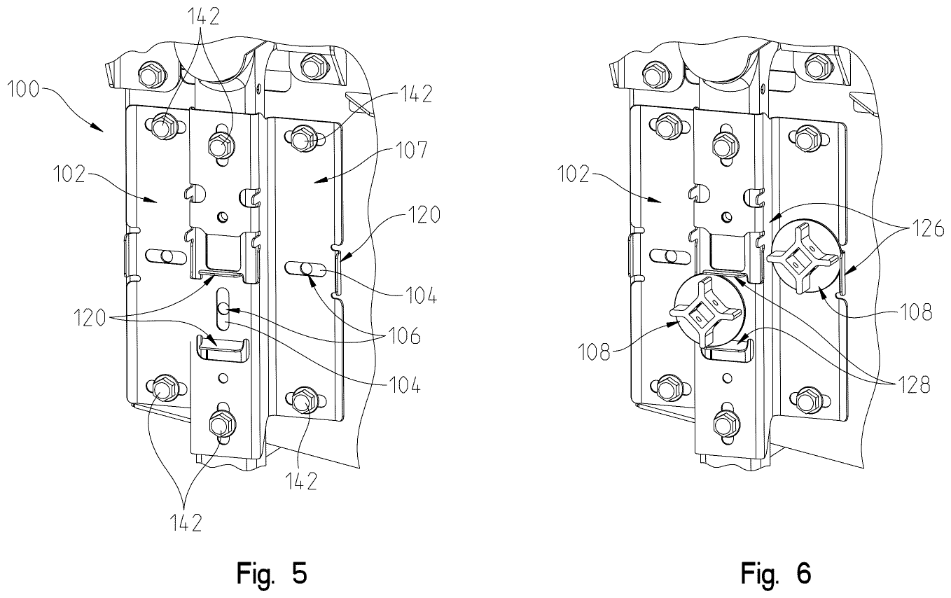

Turning to FIGS. 5-6, adjustment assembly 100 includes a body 102. Body 102 defines at least one slot 104 positioned along a front face 107 of body 102 wherein the at least one slot 104 defines recess 106. In some embodiments, recess 106 is round, but other geometric shapes are contemplated. Recess 106 may be configured to receive an adjuster 108, wherein adjuster 108 is removably coupled to body 102. In some embodiments, body 102 receives two adjusters 108, three adjusters 108, or more than three adjusters 108. As shown in FIGS. 5-8, adjustment assembly 100 may include a first adjuster 108a and a second adjuster 108b. In some embodiments, the at least one adjuster 108 may be positioned on the body 102, non-concentric with each other.

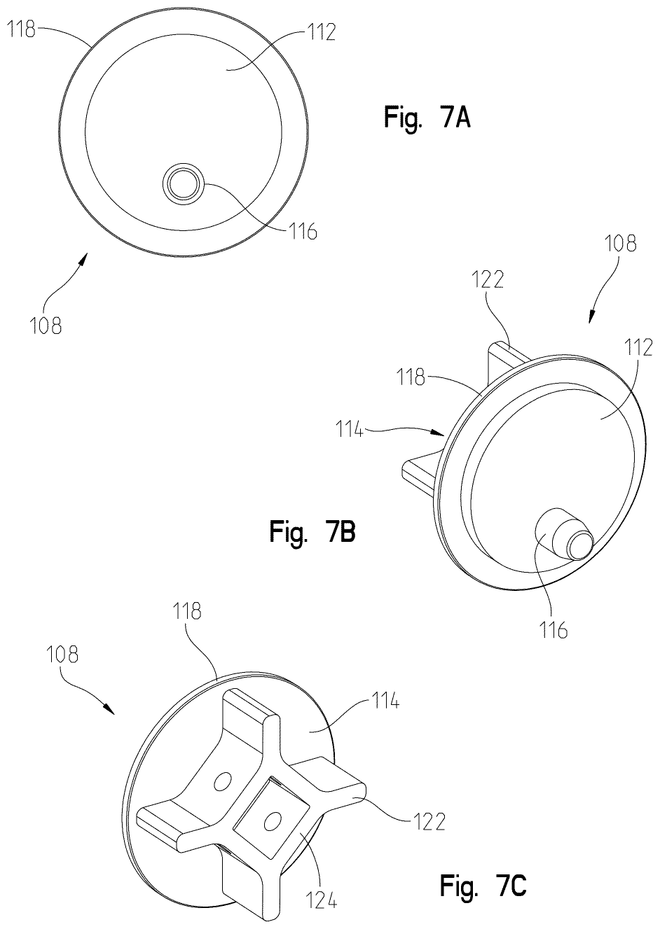

Referring to FIG. 7A-7B, adjuster 108 is shown removed from body 102. Adjuster 108 may be circular in shape, though any number of shapes are contemplated. Adjuster 108 includes an inner face 112 (e.g., as shown in FIG. 7A) where inner face 112 faces toward body 102 when adjuster 108 is coupled thereto. Adjuster 108 also includes an outer face 114 (e.g., as shown in FIG. 7C) where outer face 114 faces away from body 102 when adjuster 108 is coupled thereto.

As shown in FIG. 7A, inner face 112 may include a protrusion 116, where the protrusion 116 is configured to be received within recess 106 to removably couple adjuster 108 to body 102. Protrusion 116 may have a complementary shape to recess 106. Adjuster 108 may be rotatably coupled to the body 102 such that the adjuster 108 is rotatable relative to body 102 about protrusion 116. As shown in FIG. 7B, adjuster 108 may further include an outer perimeter 118 defined along an outer edge of the adjuster 108, where outer perimeter 118 may contact a track 120 defined along body 102. The track 120, as illustrated, may be a pair of rails positioned on opposing portions of outer perimeter 118. As illustrated, protrusion 116 may be offset from a centerpoint of the inner face 112. As such, upon rotation, adjuster 108 may move linearly along track 120.

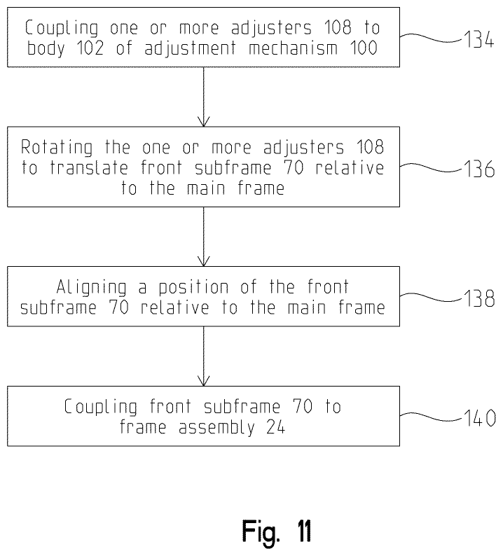

As shown in FIG. 7C, adjuster 108 may include a handle 122 on outer face 114 of the adjuster 108. Handle 122 may project outwardly relative to outer face 114. Handle 122 may include, but is not limited to, a four-sided design 124, though other shapes are contemplated. Features of handle 122 may vary and may be designed for ease of operation or improved ergonomics. Handle 122 may be configured for an operator to grip adjuster 108 during operation, which is discussed with respect to FIG. 11.

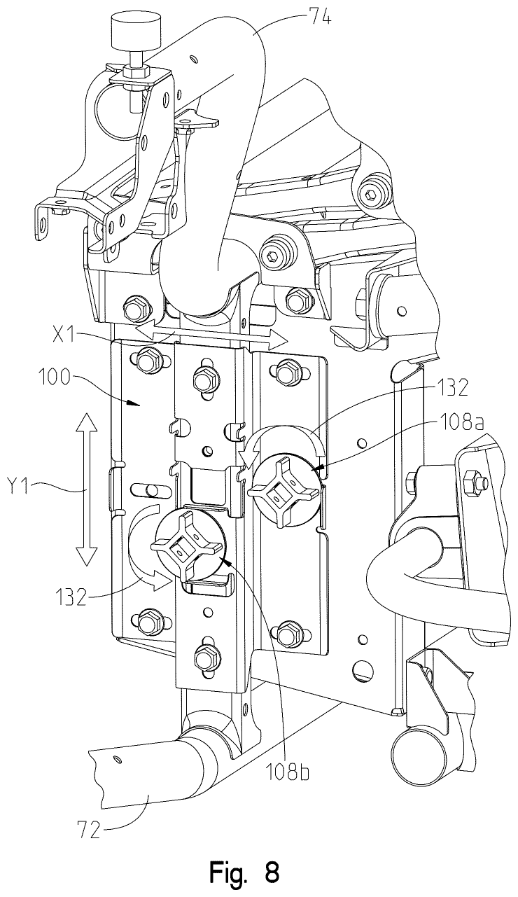

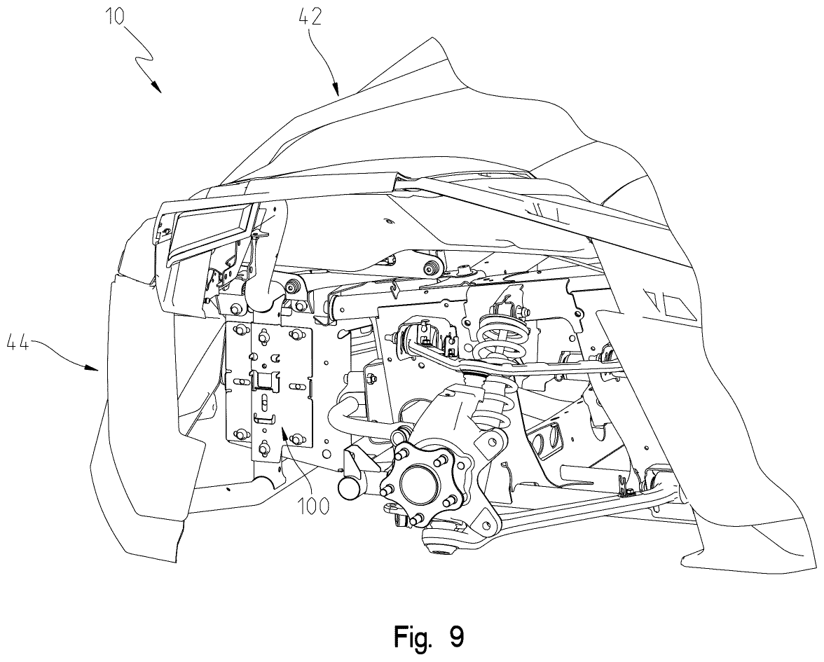

Referring to FIG. 8, the at least one adjuster 108 may be rotatable relative to body 102. Rotation of the at least one adjuster 108 may be performed during manufacturing of vehicle 10. Rotation of adjuster 108 moves, or translates, body 102, which in turn, moves front subframe 70 relative to the rest of frame assembly 24. In some embodiments, movement of the body 102 is limited to an X-Y plane, or two degrees of freedom. In such embodiments, a first adjuster 108a may translate body 102 fore and aft in an X-direction X1 (e.g., forward and rearward a longitudinal center point of vehicle 10) and a second adjuster 108b may translate body 102 up and down in a Y-direction Y1 (e.g., up and down relative to the ground). In some embodiments, body 102 is restricted from moving at an angle relative to the X-Y plane, or in other words, body 102 is only translated linearly within the X-Y plane. The restriction in angular movement may be to keep headlight assemblies 50 on front fascia 44 pointed at a desired angle relative to the ground. If front fascia 44 is moved at an angle, subsequent adjustment of headlight assemblies 50 may be required.

Further to FIG. 8, rotation of first adjuster 108a in a first rotational direction 132 translates body 102 in a first X-direction. Rotation of the first adjuster 108a in a second rotational direction, opposite to the first rotational direction 132, translates body 102 is a second X-direction, opposite to the first X-direction. Upon rotation in the first rotational direction 132, the first adjuster 108a may move linearly along first track 126 of body 102. Outer perimeter 118 of first adjuster 108a may ride along first track 126 upon rotation of first adjuster 108a.

Similarly, rotation of second adjuster 108b in first rotational direction 132 translates body 102 in a first Y-direction. Rotation of the second adjuster 108b in the second rotation direction, opposite to the first rotational direction 132, translates body 102 is a second Y-direction, opposite to the first Y-direction. Upon rotation in the first rotational direction 132, the second adjuster 108b may move linearly along second track 128 of body 102. Outer perimeter 118 of second adjuster 108b may ride along second track 128 upon rotation of second adjuster 108b.

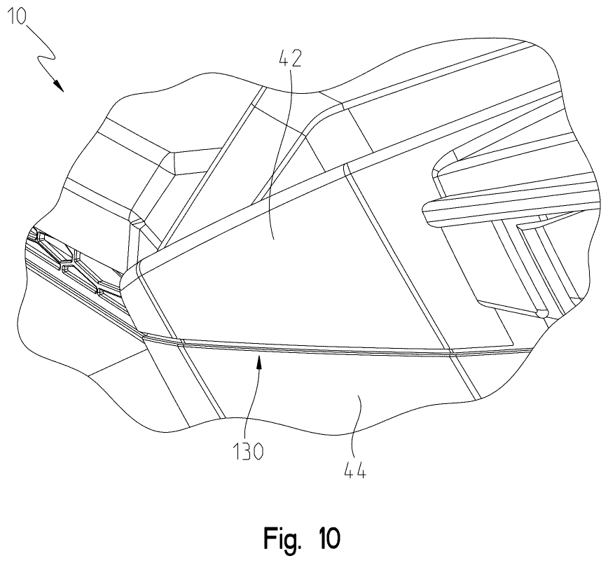

During manufacturing of vehicle 10, translation of body 102 in the X-Y plane via at least one adjuster 108 translates front subframe 70 and front fascia 44 in the X-Y plane. This allows for easy adjustment and alignment of front fascia 44 with other components of vehicle 10. In one embodiment, a position of front fascia 44 may be adjusted relative to hood 42 such that front fascia 44 and hood 42 are aligned next to each other along a common line 130, as shown in FIG. 10. In adjusting front fascia 44, for example, the front fascia 44 could first be lined up with dashboard 43 or windshield 41 and then lined up with hood 42 afterwards.

Turning to FIG. 11, a method of manufacturing or assembling vehicle 10 using adjustment assembly 100 is illustrated. Adjustment assembly 100 may be used by an assembler during assembly of vehicle 10, where the assembler may be a person performing manufacturing steps or may be a machine that is configured to perform manufacturing steps. In one step 134, the assembler may couple at least one adjuster 108 to body 102 of adjustment assembly 100. As discussed above, this may include coupling the at least one adjuster 108 to recess 106 of the adjustment assembly 100. In another step 136, the assembler rotates the at least one adjuster 108 to move front subframe 70 within at least one degree of freedom within an X-Y plane. In one embodiment, rotation of one first adjuster 108a may translate body 102 in X-direction X1 (e.g., as shown in FIG. 8). Rotation of second adjuster 108b may translate body 102 in a Y-direction Y1 (e.g., as shown in FIG. 8). In other embodiments, a single adjuster 108 may be used to rotate body 102 in the X-direction X1 and the Y-direction Y1 by coupling the single adjuster 108 to a first position to translate body 102 in the X-direction X1 and then removing the single adjuster 108 from body 102 and re-coupling to the body 102 in a second position, different from the first position, to move body 102 in the Y-direction Y1. The first position may correspond to the position of the first adjuster 108a (e.g., as shown in FIG. 8) and the second position may correspond to the position of the second adjuster 108b (e.g., as shown in FIG. 8). In another step 138, the assembler may align the position of the frame subframe 70 relative to frame assembly 24. The assembler may translate front subframe 70 using the adjustment assembly 100 until front subframe 70 is positioned as desired. For example, the assembler may align front fascia 44 with hood 42 along common line 130 between the two components. In another step 140, once front subframe 70 is positioned as desired, the assembler may couple front subframe 70 to frame assembly 24 using any of welding, fastening, and other coupling methods known in the art. In some embodiments, body 102 includes a plurality of fasteners 142 that may be tightened to couple front subframe 70 to frame assembly 24. Fasteners 142 may include, but are not limited to, bolts. In other embodiments, body 102 includes a plurality of apertures to receive fasteners (e.g., bolts) to couple front subframe 70 to frame assembly 24. In some embodiments, either before or after coupling front subframe 70 to frame assembly 24, the at least one adjuster 108 can be removed, or decoupled, from body 102. Adjusters 108 could then be re-used for assembling a second vehicle following similar assembly steps as discussed above. In some embodiments, where body 102 is not part of vehicle 10, body 102 may also be removed and re-used in assembling second vehicle. The ability of the at least one adjuster 108 to be removed and reused may contribute to a reduced bill of materials (BOM) cost of the vehicle 10. In other embodiments, adjustment assembly 100 may be used to service vehicle 10 post-assembly following similar steps as discussed above.

Adjustment assembly 100 may support a weight of front subframe 70, and may hold front subframe 70 in position, without requiring further support from the assembler. As such, the assembler is able to have both hands free to couple the front subframe 70 to frame assembly 24 and does not need to support the weight of front assembly 70.

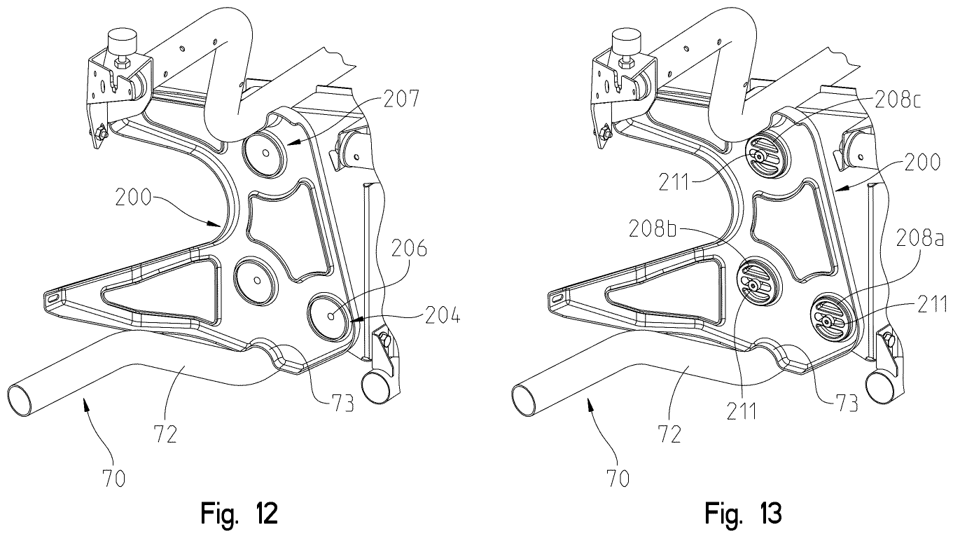

Turning to FIGS. 12-13, in another embodiment, an adjustment assembly 200 is shown. Adjustment assembly 200 may include similar features and may operate similarly as described above with respect to adjustment assembly 100. Adjustment assembly 200 may be removably coupled to or integral with front subframe 70. In one embodiment, adjustment assembly 200 may be used to mount front subframe 70 to the frame assembly 24.

Adjustment assembly 200 may include a body 202, which may be similar to body 102 as described above. As shown in FIGS. 12-13, body 202 may define at least one slot 204 positioned along a front face 207 of body 202. Slot 204 defines a recess 206 configured to receive an adjuster 208, wherein adjuster 208 is removably coupled to body 202. In some embodiments, body 102 receives two adjusters 108, three adjusters 108, or more than three adjusters 108. As shown in FIGS. 5-8, adjustment assembly 100 may include a first adjuster 108a and a second adjuster 108b. In some embodiments, the at least one adjuster 108 may be positioned on the body 202, non-concentric with each other.

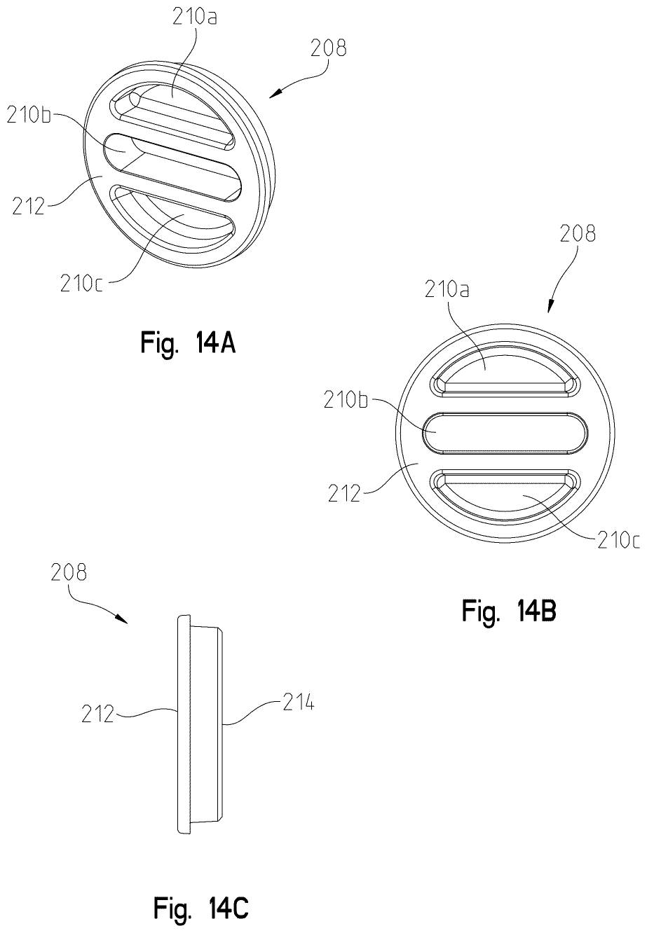

Turning to FIGS. 14A-14C, adjuster 208 is shown removed from body 202. Adjuster 208 may be circular in shape, though any number of shapes are contemplated. Adjuster 208 includes an inner face 212, where inner face 212 faces toward body 202 when adjuster 208 is coupled thereto. Adjuster 208 also includes an outer face 214 (e.g., as shown in FIG. 14B) where outer face 214 faces away from body 202 when adjuster 208 is coupled thereto. Adjuster 208 may define a plurality of apertures 210 extending from inner face 212 to outer face 214. A first aperture 210a and/or a second aperture 210c may define a handle for the assembler to grip during assembly of vehicle 10. A third aperture 210b may receive a fastener 211 therethrough (e.g., as shown in FIGS. 13), wherein fastener 211 is received in recess 206 of body 202 to removably couple adjuster 208 to body 202. Fastener 211 may include, but is not limited to, a bolt.

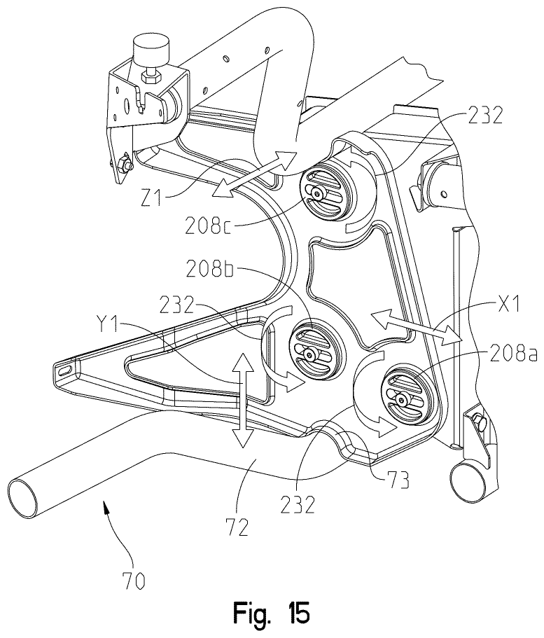

Turning to FIG. 15, the at least one adjuster 208 may be rotatable relative to body 202. The at least one adjuster 208 may rotate about the fastener 211. Similar to adjuster 108, rotation of adjuster 208 moves, or translates, body 202, which in turn, moves front subframe 70 relative to the rest of frame assembly 24 (e.g., relative to main frame). In some embodiments, front subframe 70 may translate within an X-Y-Z plane, or three degrees of freedom. In such embodiments, a first adjuster 208a may translate body 202 fore and aft in an X-direction X1 (e.g., forward and rearward a longitudinal center point of vehicle 10), a second adjuster 208b may translate body 202 up and down in a Y-direction Y1 (e.g., up and down relative to the ground), and a third adjuster 208c may translate body 202 at an angle, or a tilt, in a Z-direction Z1 (e.g., at an angle relative to an longitudinal axis of vehicle 10). The angle may be up to approximately 45 degrees, relative to the longitudinal axis of vehicle 10. When front subframe 70 and front fascia 44 are translated at an angle relative to the longitudinal axis of vehicle 10, subsequent adjustment of headlight assemblies 50 may be required.

Similar to adjustment assembly 100, in adjustment assembly 200, rotation of first adjuster 208a in a first rotational direction 232 translates body 202 in a first X-direction X1. Rotation of the first adjuster 208a in a second rotational direction, opposite to the first rotational direction 132, translates body 202 is a second X-direction, opposite to the first X-direction.

Rotation of second adjuster 208b in a first rotational direction 232 translates body 202 in a first Y-direction. Rotation of the second adjuster 208b in a second rotation direction, opposite to the first rotational direction 132, translates body 202 is a second Y-direction, opposite to the first Y-direction.

Rotation of the third adjuster 208c in a first rotational direction 132 translates the body 202 in a first Z-direction. Rotation of the third adjuster 208c in a second rotational direction, opposite to the first Z-direction, translates the body 202 in a second Z-direction, opposite to the first Z-direction. The Z-direction may tilt front subframe 70 forward or backward relative to a longitudinal axis of vehicle 10.

During assembly, of vehicle 10, translation of body 202 in the X-Y-Z plane via at least one adjuster 208 translates front subframe 70 and front fascia 44 in the X-Y-Z plane. As described with respect to FIG. 10, the adjustment assembly 200 allows for easy adjustment and alignment of front fascia 44 with other components of vehicle 10.

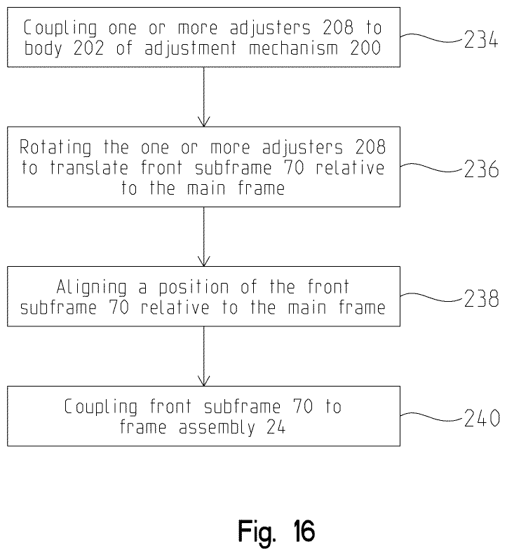

Turning to FIG. 16, a method of manufacturing, or assembly, of vehicle 10 using adjustment assembly 200 is illustrated. Using adjustment assembly 100 during assembly of vehicle 10 may be done by an assembler, where the assembler may be a person performing manufacturing steps or may be a machine that is configured to perform manufacturing steps. The method of FIG. 16 may be similar to the method of using adjustment assembly 100, as shown in FIG. 11. In one step 234, the assembler may couple at least one adjuster 208 to body 202 of adjustment assembly 200. In another step 236, the assembler rotates the at least one adjuster 208 to move front subframe 70 within at least one degree of freedom within an X-Y-Z plane. In one embodiment, rotation of first adjuster 208a may move body 202 in X-direction X1 (e.g., as shown in FIG. 15). Rotation of second adjuster 208b may move body 202 in a Y-direction Y1 (e.g., as shown in FIG. 15). Rotation of third adjuster 208c may move body 202 in Z-direction Z1 (e.g., as shown in FIG. 15). In other embodiments, a single adjuster 208 may be used to rotate body 202 in the X-direction X1, the Y-direction Y1, and the Z-direction Z1 by coupling the single adjuster 208 to a first position to move body 202 in one of the X, Y, or Z directions and then removing the single adjuster 208 from body 102 and re-coupling the single adjuster 208 to the body 102 in a second position or a third position, different from the first position, to move the body in another of the X, Y, and Z directions. The first position may correspond to the position of the first adjuster 208a (e.g., as shown in FIG. 15), the second position may correspond to the position of the second adjuster 208b (e.g., as shown in FIG. 15), and the third position may correspond to the position of the third adjuster 208c (e.g., as shown in FIG. 15). In another step 238, the assembler may align a position of frame subframe 70 relative to frame assembly 24. The assembler may translate front subframe 70 until front subframe 70 is positioned as desired. For example, the assembler may align front fascia 44 with hood 42 along common line 130 between the two components. If front subframe 70 is moved in Z-direction Z1, further adjustment of headlight assemblies 50 may be required such that headlight assemblies 50 are pointed toward the ground. In another step 240, once front subframe 70 is positioned as desired, the assembler may couple front subframe 70 to frame assembly 24 using any of welding, fastening, and other methods known in the art. In some embodiments, body 202 includes a plurality of fasteners that may be tightened to couple front subframe 70 to frame assembly 24. In other embodiments, body 202 includes a plurality of apertures to receive fasteners (e.g., bolts) to couple front subframe 70 to frame assembly 24.

Adjustment assembly 200 may support a weight of front subframe 70, and may hold front subframe 70 in position, without requiring further support from the assembler. As such, the assembler is able to have both hands free to couple the front subframe 70 to frame assembly 24 and does not need to support the weight of front assembly 70.

After assembly, either before or after coupling front subframe 70 to frame assembly 24, the at least one adjuster 208 can be removed, or decoupled, from body 202. Removing the at least one adjuster 208 may include loosening and removing fastener 211 from body 202. Adjusters 208 could then be re-used for assembling a second vehicle following similar steps as discussed above. In some embodiments, after at least one adjuster 208 are removed, fasteners 211 may be re-coupled to recess 206 and tightened to couple front subframe 70 to frame assembly 24. In some embodiments, where body 202 is not part of vehicle 10, body 202 may also be removed and re-used in assembling second vehicle. The ability of the at least one adjuster 108 to be removed and reused may contribute to a reduced bill of materials (BOM) cost of the vehicle 10. In other embodiments, adjustment assembly 100 may be used to service vehicle 10 post-assembly following similar steps as discussed above.

The following clauses are provided as example aspects of the disclosed subject matter:

Clause 1: A vehicle comprising: a plurality of ground engaging members; a frame assembly supported by the plurality of ground engaging members, the frame assembly including a main frame and a front subframe; a powertrain operatively coupled to at least one of the plurality of ground engaging members; a plurality of body panels supported by the front subframe and including a front fascia; and an adjustment assembly operably coupled to the front subframe, the adjustment assembly including: a body, and at least one adjuster removably coupled to the body, the at least one adjuster being rotatable relative to the body wherein rotation of the at least one adjuster translates the front subframe relative to the main frame, wherein the adjustment assembly is configured to translate within at least two degrees of freedom.

Clause 2: The vehicle of clause 1, wherein the body includes a track and the at least one adjuster rides within the track.

Clause 3: The vehicle of clause 1, wherein the at least one adjuster includes a first adjuster and a second adjuster, wherein the first adjuster translates the body in an X-direction and the second adjuster translates the body in a Y-direction.

Clause 4: The vehicle of clause 1, wherein the at least one adjuster includes a handle.

Clause 5: The vehicle of clause 1, wherein the at least one adjuster translates the front subframe at an angle with respect to a vertical direction and a longitudinal direction of the vehicle.

Clause 6: The vehicle of clause 1, wherein the body defines a recess, and the at least one adjuster includes a protrusion, wherein the protrusion is received within the recess to couple the one more adjusters to the body.

Clause 7: The vehicle of clause 1, wherein the body defines a recess and the at least one adjuster defines an aperture, and the at least one adjuster is coupled to the body via a fastener received through the aperture and within the recess.

Clause 8: The vehicle of clause 1, wherein the plurality of body panels further includes a hood, and the front fascia is translated to align with the hood.

Clause 9: An adjustment assembly for adjusting position of a front subframe of a vehicle relative to a main frame, the adjustment assembly comprising: a body; and at least one adjuster removably coupled to the body, wherein the at least one adjuster is rotatable relative to the body, and wherein the adjustment assembly is configured to translate within at least two degrees of freedom.

Clause 10: The adjustment assembly of clause 9, wherein the adjustment assembly is configured to translate within three degrees of freedom.

Clause 11: The adjustment assembly of clause 9, wherein the at least one adjuster includes a first adjuster and a second adjuster, wherein the first adjuster translates the body in an X-direction and the second adjuster translates the body in a Y-direction.

Clause 12: The adjustment assembly of clause 11, wherein the at least one adjuster further includes a third adjuster, wherein the third adjuster translates the body in a Z-direction.

Clause 13: The adjustment assembly of clause 9, wherein the at least one adjuster includes a handle.

Clause 14: The adjustment assembly of clause 9, wherein the body defines a recess, and the at least one adjuster includes a protrusion, wherein the protrusion is received within the recess to couple the at least one adjuster to the body.

Clause 15: The adjustment assembly of clause 9, wherein the body defines an aperture, and the at least one adjuster is coupled to the body via a fastener received within the aperture.

Clause 16: A method of manufacturing a vehicle comprising: providing a plurality of ground engaging members; providing a powertrain, the powertrain being operatively coupled to at least one of the plurality of ground engaging members; providing a frame assembly supported by the plurality of ground engaging members, the frame assembly including a main frame and a front subframe; providing a plurality of body panels supported by the frame assembly, the plurality of body panels including a front fascia and a hood; providing an adjustment assembly comprising at least one adjuster and a body, the adjustment assembly being operatively coupled to the front subframe; coupling the at least one adjuster to the body; rotating the at least one adjuster to translate the front subframe relative to the main frame, wherein the adjustment assembly is configured to translate within at least two degrees of freedom; aligning the front subframe relative to the main frame; and coupling the front subframe to the frame assembly.

Clause 17: The method of clause 16, further comprising removing the at least one adjuster from the body.

Clause 18: The method of clause 16, wherein aligning the front subframe further comprises aligning the front fascia with the hood.

Clause 19: The method of clause 16, wherein rotating the at least one adjuster further comprises rotating a first adjuster in an x-direction and rotating a second adjuster in a y-direction.

Clause 20: The method of clause 19, wherein rotating the at least one adjuster further comprises rotating a third adjuster in a z-direction.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A vehicle comprising:
a plurality of ground engaging members;
a frame assembly supported by the plurality of ground engaging members, the frame assembly including a main frame and a front subframe;
a powertrain operatively coupled to at least one of the plurality of ground engaging members;
a plurality of body panels supported by the front subframe and including a front fascia; and
an adjustment assembly operably coupled to the front subframe, the adjustment assembly including:
a body, and
at least one adjuster removably coupled to the body, the at least one adjuster being rotatable relative to the body wherein rotation of the at least one adjuster translates the front subframe relative to the main frame,
wherein the adjustment assembly is configured to translate within at least two degrees of freedom.

2. The vehicle of claim 1, wherein the body includes a track and the at least one adjuster rides within the track.

3. The vehicle of claim 1, wherein the at least one adjuster includes a first adjuster and a second adjuster, wherein the first adjuster translates the body in an X-direction and the second adjuster translates the body in a Y-direction.

4. The vehicle of claim 1, wherein the at least one adjuster includes a handle.

5. The vehicle of claim 1, wherein the at least one adjuster translates the front subframe at an angle with respect to a vertical direction and a longitudinal direction of the vehicle.

6. The vehicle of claim 1, wherein the body defines a recess, and the at least one adjuster includes a protrusion, wherein the protrusion is received within the recess to couple the one more adjusters to the body.

7. The vehicle of claim 1, wherein the body defines a recess and the at least one adjuster defines an aperture, and the at least one adjuster is coupled to the body via a fastener received through the aperture and within the recess.

8. The vehicle of claim 1, wherein the plurality of body panels further includes a hood, and the front fascia is translated to align with the hood.

9. An adjustment assembly for adjusting a position of a front subframe of a vehicle relative to a main frame, the adjustment assembly comprising:
a body; and
at least one adjuster removably coupled to the body,
wherein the at least one adjuster is rotatable relative to the body, and
wherein the adjustment assembly is configured to translate within at least two degrees of freedom.

10. The adjustment assembly of claim 9, wherein the adjustment assembly is configured to translate within three degrees of freedom.

11. The adjustment assembly of claim 9, wherein the at least one adjuster includes a first adjuster and a second adjuster, wherein the first adjuster translates the body in an X-direction and the second adjuster translates the body in a Y-direction.

12. The adjustment assembly of claim 11, wherein the at least one adjuster further includes a third adjuster, wherein the third adjuster translates the body in a Z-direction.

13. The adjustment assembly of claim 9, wherein the at least one adjuster includes a handle.

14. The adjustment assembly of claim 9, wherein the body defines a recess, and the at least one adjuster includes a protrusion, wherein the protrusion is received within the recess to couple the at least one adjuster to the body.

15. The adjustment assembly of claim 9, wherein the body defines an aperture, and the at least one adjuster is coupled to the body via a fastener received within the aperture.

16. A method of manufacturing a vehicle comprising:
providing a plurality of ground engaging members;
providing a powertrain, the powertrain being operatively coupled to at least one of the plurality of ground engaging members;
providing a frame assembly supported by the plurality of ground engaging members, the frame assembly including a main frame and a front subframe;
providing a plurality of body panels supported by the frame assembly, the plurality of body panels including a front fascia and a hood;
providing an adjustment assembly comprising at least one adjuster and a body, the adjustment assembly being operatively coupled to the front subframe;
coupling the at least one adjuster to the body;
rotating the at least one adjuster to translate the front subframe relative to the main frame, wherein the adjustment assembly is configured to translate within at least two degrees of freedom;
aligning the front subframe relative to the main frame; and
coupling the front subframe to the frame assembly.

17. The method of claim 16, further comprising removing the at least one adjuster from the body.

18. The method of claim 16, wherein aligning the front subframe further comprises aligning the front fascia with the hood.

19. The method of claim 16, wherein rotating the at least one adjuster further comprises rotating a first adjuster in an x-direction and rotating a second adjuster in a y-direction.

20. The method of claim 19, wherein rotating the at least one adjuster further comprises rotating a third adjuster in a z-direction.
